(19) United States
(12) Patent Application Publication
(10) Pub. No.: US 2008/0246431 A1
(43) Pub. Date: Oct. 9, 2008

(54) Apparatus and method of driving compressor

(75) Inventors: Hamaoka Koji, Gwangju (KR); Han Joo Yoo, Gwangju (KR); Pyeong Ki Park, Gwangju (KR); Jeong Ho Seo, Gwangju (KR); Kwang Kyo Oh, Gwangju (KR); Hun Yub Bae, Gwangju (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/068,032

(22) Filed: Jan. 31, 2008

(30) Foreign Application Priority Data
Apr. 5, 2007 (KR) 10-2007-0033882

(51) Int. Cl. H02P 27/06

(52) U.S. Cl. 318/801; 318/470; 318/268

(57) ABSTRACT

Disclosed herein are an apparatus and method for driving a compressor, which are capable of being suitably used for driving a refrigeration system such as a refrigerator with high efficiency and low noise. The compressor driving apparatus including a motor and a compressor driven by the motor includes an inverter which supplies power to the motor to drive the motor; a rotator position detector which detects the position of a rotator of the motor; and an inverter drive controller which includes at least one wave generator for generating an optimal driving wave according to an operation mode and a control mode of the motor, stores the generated optimal driving wave, and drives the inverter with the generated wave.

### CROSS-REFERENCE TO RELATED APPLICATIONS

This application claims the benefit of Korean Patent Application No. 2007-33882, filed on Apr. 5, 2007 in the Korean Intellectual Property Office, the disclosure of which is incorporated herein by reference.

### BACKGROUND

1. Field

The present invention relates to a compressor, and, more particularly, to an apparatus and method of driving a compressor, which are capable of being suitably used to drive a refrigeration system such as a refrigerator with high efficiency and low noise.

2. Description of the Related Art

Recently, in a refrigeration system such as a refrigerator, a countermeasure to save energy is being researched for the purpose of protection of the global environment. In order to realize such energy saving, a refrigeration system such as a refrigerator should be operated at a low speed.

However, if a room temperature rises due to opening/closing of a door when a temperature is high (i.e., in the summer season), or a load is increased after defrosting, the room temperature should rapidly fall to a predetermined temperature. Accordingly, a high-speed operation is required.

Conventionally, if a low-speed operation with high efficiency and low noise are preferentially required, a high-speed operation cannot be performed at the time of a high load. In contrast, if a high-speed operation is preferentially required at the time of a high load, a low-speed operation with high efficiency and low noise cannot be performed.

In order to solve such a problem, a method of switching a wave according to a high-speed operation or a low-speed operation is disclosed in Japanese Unexamined Patent Application Publication No. 2004-129379.

FIG. 1 is a block diagram showing a conventional apparatus to drive a compressor.

As shown in FIG. 1, the conventional apparatus to drive the compressor includes a DC power source 110, a capacitor 120 to remove an AC component in the DC power source 110, an inverter 130 to convert a DC voltage of DC power source 110 into a 3-phase AC voltage and supply the 3-phase AC voltage to a motor 140, a position sensor 150 to detect an operation position of a rotator of the motor 140, a driver 170 to select an optimal driving phase and drive the inverter 130, a rotation number detector 160 to detect a rotation number, output a wave for a low-speed operation if the rotation number is less than a predetermined rotation number, and output a wave for a high-speed operation if the rotation number is greater than the predetermined rotation number, such that the driver 170 drives the inverter 130.

However, when the conventional apparatus to drive the compressor performs 180° rectangular wave driving, and a portion in which a difference between an applied voltage and a motor induction voltage is increased occurs. In this portion, current is significantly distorted and abnormal noise occurs.

When the conventional apparatus to drive the compressor performs the 180° rectangular wave driving, switching loss of a power element is also increased to decrease efficiency and the power element emits a large amount of heat to reduce the lifetime of the refrigerator.

### SUMMARY

Therefore, it is an aspect of the embodiment to provide an apparatus and method of driving a compressor, which are capable of improving operation efficiency at the time of a low-speed operation and reducing noise at the time of a high-speed operation.

It is another aspect of the embodiment to provide an apparatus and method of driving a compressor, which are capable of reducing switching loss of a power element to reduce a heating value.

Additional aspects and/or advantages will be set forth in part in the description which follows and, in part, will be obvious from the description, or may be learned by practice of the invention.

In accordance with the invention, the above and/or other aspects can be achieved by the provision of a compressor driving apparatus including: a motor including a rotator; a compressor driven by the motor; an inverter supplying power to the motor to drive the motor; a rotator position detector detecting a position of the rotator of the motor; and an inverter drive controller including at least one wave generator generating an optimal driving wave according to an operation mode and a control mode of the motor and the detected position of the rotator, storing the generated optimal driving wave, and driving the inverter with the generated wave.

The inverter drive controller may include first, second and third wave generators that generate driving waves using an output signal of the rotator position detector. The inverter drive controller may drive the inverter with the wave generated by any one of the first wave generator and the second wave generator when a rotation number detected by the output signal of the rotator position detector is less than a predetermined rotation number, and drive the inverter with the wave generated by the third wave generator when the rotation number detected by the output signal is greater than or equal to the predetermined rotation number.

The first wave generator of the inverter drive controller may generate a 120° rectangular wave, and the 120° rectangular wave may have an energization angle of approximately 120 degrees to 130 degrees.

The second wave generator of the inverter drive controller may generate a sine wave, the third wave generator of the inverter drive controller may generate a 150° rectangular wave, and the 150° rectangular wave may have an energization angle of approximately 140 degrees to 160 degrees.

The inverter drive controller may drive the inverter with the wave generated by the second wave generator in order to reduce noise due to the driving of the motor, and drive the inverter with the wave generated by the first wave generator in order to improve operation efficiency of the motor.

The motor may be a brushless DC motor.

The foregoing and/or other aspects are achieved by providing a method of driving a compressor using a motor and an inverter of supplying power to the motor to drive the motor, the method including: detecting a rotation number of the motor; comparing the detected rotation number with a predetermined reference rotation number; and generating an optimal driving wave according to an operation mode and a control mode of the motor and the result of the comparison to drive the inverter.

The method further includes selecting any one of a 120° rectangular wave and a sine wave to drive the inverter when it is determined that the detected rotation number of the motor is less than the predetermined reference rotation number, and, selecting a 150° rectangular wave to drive the inverter when it is determined that the detected rotation number of the motor is greater than or equal to the predetermined reference rotation number.

The method further includes determining whether high operation efficiency or reduction of noise is required to select the wave when the detected rotation number of the motor is less than the predetermined reference rotation number a 120° rectangular wave may be selected when it is determined that the high operation efficiency is required, and a sine wave may be selected when it is determined that the reduction of noise is required.

The 120° rectangular wave may have an energization angle of approximately 120 degrees to 130 degrees, and the 150° rectangular wave may have an energization angle of approximately 140 degrees to 160 degrees.

The foregoing and/or other aspects are achieved by providing a compressor driving apparatus, including: a motor including a rotator; an inverter supplying power to the motor; a rotator position detector detecting a position of the rotator of the motor; and an inverter drive controller including at least two wave generators each generating an optimal driving wave according to a result of the detected position of the rotator.

The optimal driving wave may be generated according to a high speed operation or a low speed operation, one of the wave generators generating a 150° rectangular wave according to the high speed operation and at least one other of the wave generators generating one of a sine wave and a 120° rectangular wave according to the lower speed operation.

A first of the at least one other of the wave generators may generate the 120° rectangular wave when a high efficiency operation is required and a second of the at least one other of the wave generators may generate the sine wave when a high efficiency operation is not required.

### BRIEF DESCRIPTION OF THE DRAWINGS

These and/or other aspects and advantages will become apparent and more readily appreciated from the following description of the embodiment, taken in conjunction with the accompanying drawings of which:

FIG. 1 is a block diagram showing a conventional apparatus of driving a compressor;

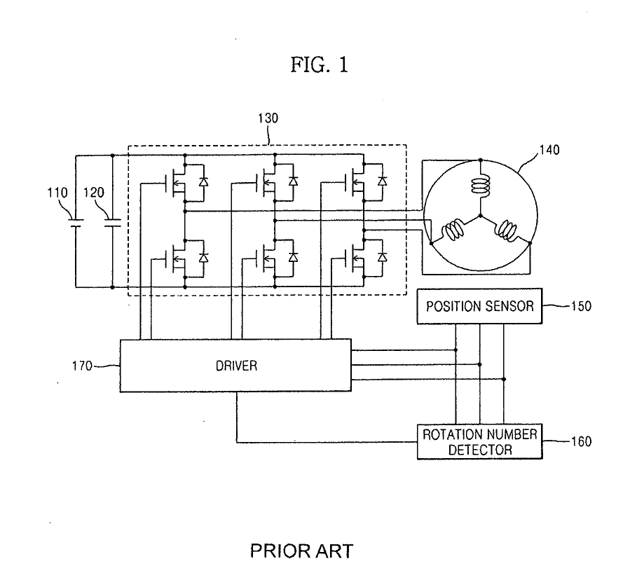

FIG. 2 is a block diagram showing an apparatus of driving a compressor according to an embodiment;

FIG. 3 is a characteristic diagram showing a relationship between an energization angle of a rectangular wave and a maximum rotation number of a motor according to the embodiment; and

FIG. 4 is a flowchart illustrating a method of driving a compressor according to the embodiment.

### DETAILED DESCRIPTION OF THE EMBODIMENTS

Reference will now be made in detail to the embodiment, examples of which are illustrated in the accompanying drawings, wherein like reference numerals refer to the like elements throughout. The embodiment is described below to explain the present invention by referring to the Figures.

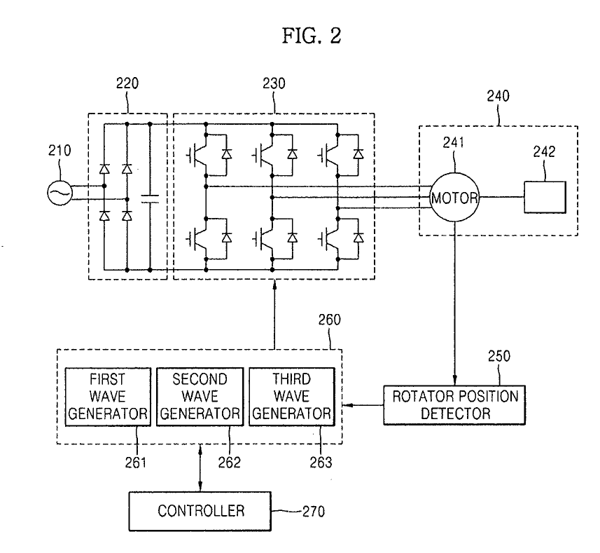

FIG. 2 is a block diagram showing an apparatus to drive a compressor according to an embodiment.

As shown in FIG. 2, the apparatus to drive the compressor according to the embodiment includes a rectifier 220 to rectify a voltage of an AC power source 210 and supply a DC voltage, an inverter 230 to convert the DC voltage supplied from the rectifier 220 into a 3-phase AC voltage (U, V, W) and supply the 3-phase AC voltage to a compressor 240, a rotator position detector 250 detecting a position of a rotator of the compressor 240, an inverter drive controller 260 generating an optimal driving wave using an output signal of the rotator position detector 250 and driving the inverter 230 with the generated wave, and a controller 270 controlling an operation of a load.

The compressor 240 includes a motor 241 driven by the three-phase AC voltage supplied from the inverter 230 and a compression tool 242 to convert rotation power of the motor 241 into compression power. The motor 241 operating the compressor 240 may be, for example, a brushless DC motor to obtain high efficiency, and may be a sensorless motor since a position sensor is not included.

The inverter drive controller 260 includes first, second and third wave generators 261, 262 and 263 detecting a rotation number N of the motor 241 by the output signal of the rotator position detector 250, comparing the rotation number N with a predetermined reference number N1 and generating the optimal driving wave.

The first wave generator 261 of the inverter drive controller 260 generates a 120° rectangular wave to drive the inverter 230 if the rotation number N of the motor 241 is less than the predetermined reference rotation number N1. At this time, the energization angle of the 120° rectangular wave is preferably in a range from 120 degrees to 130 degrees which can obtain the same characteristic as when the inverter is driven with the 120° rectangular wave.

The second wave generator 262 generates a sine wave to drive the inverter 230 if the rotation number N of the motor 241 is less than the predetermined reference rotation number N1.

If the rotation number N of the motor 241 is less than the predetermined reference rotation number N1, the inverter drive controller 260 selects any one of the 120° rectangular wave generated by the first wave generator 261 and the sine wave generated by the second wave generator 262 to drive the inverter 230. For high efficiency of the operation of the motor 241, the 120° rectangular wave generated by the first wave generator 261 is selected to drive the inverter 230 and, for reduction of noise, the sine wave generated by the second wave generator 262 is selected to drive the inverter 230. The reason that the inverter is driven by such a method will be described later.

Finally, the third wave generator 263 generates a 150° rectangular wave if the rotation number N of the motor 241 is greater than or equal to the predetermined reference rotation number N1. At this time, the energization angle of the 150° rectangular wave is preferably in a range from 140 degrees to 160 degrees which can obtain the same characteristic as when the inverter is driven with the 150° rectangular wave.

The reason that the inverter 230 is driven with different waves according to the rotation number N of the motor 241 is as follows.

A maximum effective voltage of the wave generated by the inverter drive controller 260 is proportional to the rotation number N of the motor 241. Accordingly, the effective voltages of the waves generated by the wave generators 261-263 of the inverter drive controller 260 are as follows.

The maximum effective voltage of the 120° rectangular wave generated by the first wave generator 261 can be obtained using Equation 1.

$$Vrms = \sqrt{\frac{t 2}{t 1} \times {Vdc}^{2}} \qquad Equation 1$$

where, Vrms denotes a maximum effective voltage, t1 denotes an energization time, t2 denotes a period, and Vdc denotes a DC voltage. If the DC voltage Vdc is 300 V, the maximum effective voltage of the 120° rectangular wave is 245 V.

The maximum effective voltage of the sine wave generated by the second wave generator 262 can be obtained using Equation 2.

$$Vrms = \frac{Vdc}{\sqrt{2}} \qquad Equation 2$$

It can be seen from Equation 2 that the maximum effective voltage of the sine wave is 212 if the DC voltage Vdc is 300 V.

It can be seen from Equation 1 that the maximum effective voltage of the 150° rectangular wave generated by the third wave generator 263 is 274 V if the DC voltage Vdc is 300 V.

Finally, it can be seen from Equation 1 that the maximum effective voltage of the conventional 180° rectangular wave is 300 V if the DC voltage Vdc is 300 V.

Since the maximum effective voltages of the waves are proportional to the rotation number of the motor 241 as described above, it can be seen that the operation efficiency of the motor 241 is increased as the maximum effective voltage is increased. The high operation efficiency of the motor 241 indicates the high-speed operation and the low operation efficiency of the motor 241 indicates the low-speed operation.

Next, the occurrence of noise according to the waves will be described.

In general, noise occurs by phase commutation of the current of the apparatus to drive the compressor. The level of noise is proportional to dl/dt and the frequency thereof is equal to the number of phase commutations per second.

When the inverter 230 is driven with the conventional 180° rectangular wave, a difference between the applied voltage and the induction voltage upon phase commutation is significantly large and thus a large dl/dt is obtained. Accordingly, current is significantly distorted and thus noise is high.

However, when the inverter 230 is driven with the 150° rectangular wave generated by the third wave generator 263 of the apparatus to drive the compressor according to the embodiment, a voltage difference of the 150° rectangular wave is smaller than that of the conventional 180° rectangular wave and noise is lower compared with the conventional 180° rectangular wave.

When the inverter 230 is driven with the 120° rectangular wave generated by the first wave generator 261 of the apparatus to drive the compressor according to the embodiment, a voltage difference of the 120° rectangular wave is smaller than that of a 180° sine wave or a 150° sine wave and noise is lower than compared with the 180° sine wave or the 150° sine wave.

When the inverter 230 is driven with the sine wave generated by the second wave generator 262, the sine wave does not cause phase commutation of current and thus noise hardly occurs due to the phase commutation of current.

Accordingly, it can be seen that the sine wave causes lowest noise due to the phase commutation of current.

In addition, noise also occurs due to a carrier frequency. This occurs due to a difference in modulation method, not due to a waveform difference.

In general, if the carrier frequency is increased, the noise of the apparatus to drive the compressor is increased. In contrast, if the carrier frequency is decreased, the noise of the apparatus to drive the compressor is decreased.

In order to reduce the noise due to the carrier frequency, the carrier frequency is preferably equal to or greater than 20 kHz. However, when the carrier frequency is equal to or greater than 20 kHz, the switching number of a power element is increased. Thus, switching loss is increased and operation efficiency deteriorates. The carrier frequency should be determined in consideration of the operation efficiency and noise. This is because the switching loss is substantially proportional to the switching number.

In the switching losses of the waves, if the switching loss of the 120° rectangular wave is 1, the switching loss of the 150° rectangular wave is 1.25, the switching loss of the conventional 180° rectangular wave is 1.5, and the switching loss of the sine wave is 3.

In order to reduce the switching loss to reduce a heating value and simultaneously realize the high-speed operation of the motor 241 and low noise, the 150° rectangular wave is most suitable. In order to realize high operation efficiency at the time of the low-speed operation, the 120° rectangular wave is most suitable, and, in order to realize low noise at the time of the low-speed operation, the sine wave is most suitable.

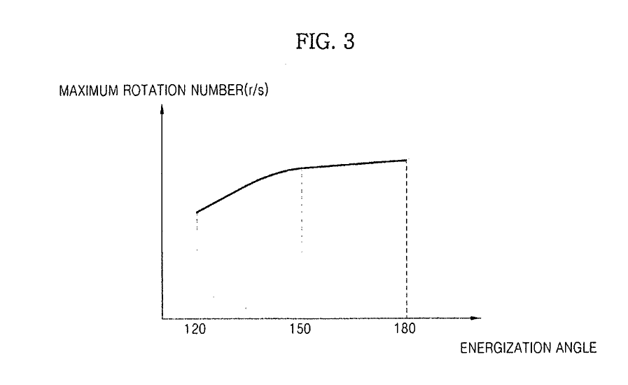

The energization angle of the wave and a maximum rotation number are shown in FIG. 3.

FIG. 3 is a characteristic diagram showing a relationship between an energization angle of a rectangular wave and a maximum rotation number of the motor according to the embodiment.

Referring to FIG. 3, it can be seen that the maximum rotation number of the motor is significantly increased if the energization angle of the rectangular wave is in a range from 120 degrees to 150 degrees, but is slightly changed if the energization angle of the rectangular wave is in a range from 150 degrees to 180 degrees.

Accordingly, the energization degree of the 120° rectangular wave generated by the first wave generator 261 is preferably in a range from 120 degrees to 130 degrees having the same characteristic as the 120° rectangular wave, and the energization degree of the 150° rectangular wave generated by the third wave generator 263 is preferably in a range from 140 degrees to 160 degrees having the same characteristic as the 150° rectangular wave.

Next, a method of driving the compressor according to the embodiment will be described.

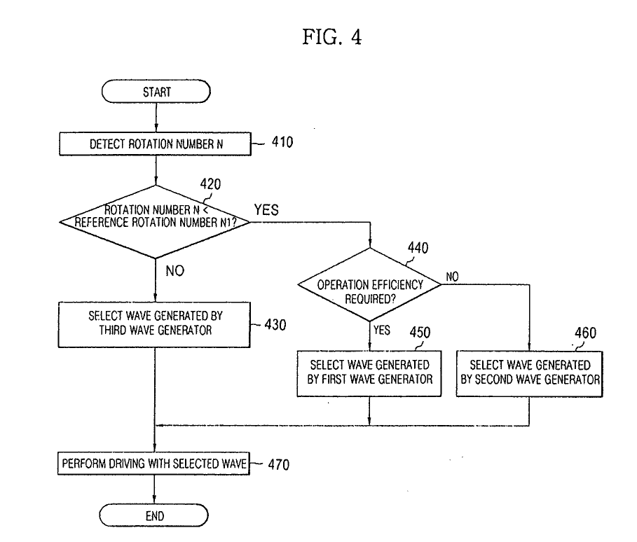

Referring to FIG. 4, in the method of driving the compressor according to the embodiment, when the rotator position detector 250 detects the position of the rotator, the inverter drive controller 260 detects the rotation number N of the rotator (410) and compares the rotation number N with the predetermined reference rotation number N1 to determine whether the rotation number N is less than the reference rotation number N1 (420).

If the rotation number N of the rotator is greater than or equal to the predetermined reference number N1, it is determined that the motor 241 is operated at a high speed. Accordingly, the inverter drive controller 260 selects the 150° rectangular wave generated by the third wave generator 263 (430).

In contrast, if the rotation number N of the rotator is less than the predetermined reference number N1, it is determined that the motor 241 is operated at a low speed. Accordingly, the inverter drive controller 260 selects any one of the 120° rectangular wave generated by the first wave generator 261 and the sine wave generated by the second wave generator 262.

The inverter drive controller 260 determines whether the low-speed operation of the motor 241 and high efficiency of the operation are required (440). If it is determined that the high efficiency of the operation is required, the 120° rectangular wave generated by the first wave generator 261 is selected (450), and, if the reduction of noise is required, the sine wave generated by the second wave generator 262 is selected (460).

Thereafter, the inverter drive controller 260 drives the inverter 230 with the selected wave (470).

Accordingly, the apparatus and method of driving the compressor according to the embodiment can achieve low noise and high efficiency at the time of a low-speed operation or a high-speed operation of the motor 241.

As described above, according to the apparatus and method of driving the compressor according to the present embodiment, operation efficiency can be improved and noise can be reduced at the time of a low-speed operation or a high-speed operation of a driving device.

According to the apparatus and method of driving the compressor according to the present embodiment, the switching loss of a power element is reduced to reduce a heating value. Thus, the lifetime of a product is increased.

Although an embodiment has been shown and described, it would be appreciated by those skilled in the art that changes may be made in these embodiments without departing from the principles and spirit of the invention, the scope of which is defined in the claims and their equivalents.

What is claimed is:

1. A compressor driving apparatus, comprising:
a motor including a rotator;
a compressor driven by the motor;
an inverter supplying power to the motor to drive the motor;
a rotator position detector detecting a position of the rotator of the motor; and
an inverter drive controller including first, second and third wave generators each generating an optimal driving wave according to an operation mode and a control mode of the motor and the detected position of the rotator, storing the generated optimal driving wave, and driving the inverter with the generated wave, the first, second and third wave generators each generating driving waves using an output signal of the rotator position detector.

2. The compressor driving apparatus according to claim 1, wherein the inverter drive controller drives the inverter with the wave generated by any one of the first wave generator and the second wave generator when a rotation number detected by the output signal of the rotator position detector is less than a predetermined rotation number, and drives the inverter with the wave generated by the third wave generator when the rotation number detected by the output signal is greater than or equal to the predetermined rotation number.

3. The compressor driving apparatus according to claim 1, wherein the first wave generator of the inverter drive controller generates a 120° rectangular wave.

4. The compressor driving apparatus according to claim 3, wherein the 120° rectangular wave has an energization angle of approximately 120 degrees to 130 degrees.

5. The compressor driving apparatus according to claim 1, wherein the second wave generator of the inverter drive controller generates a sine wave.

6. The compressor driving apparatus according to claim 1, wherein the third wave generator of the inverter drive controller generates a 150° rectangular wave.

7. The compressor driving apparatus according to claim 6, wherein the 150° rectangular wave has an energization angle of approximately 140 degrees to 160 degrees.

8. The compressor driving apparatus according to claim 2, wherein the inverter drive controller drives the inverter with the wave generated by the second wave generator in order to reduce noise due to the driving of the motor.

9. The compressor driving apparatus according to claim 2, wherein the inverter drive controller drives the inverter with the wave generated by the first wave generator in order to improve operation efficiency of the motor.

10. A method of driving a compressor using a motor and an inverter supplying power to the motor to drive the motor, the method comprising:
detecting a rotation number of the motor;
comparing the detected rotation number of the motor with a predetermined reference rotation number; and
generating an optimal driving wave according to an operation mode and a control mode of the motor and the result of the comparison to drive the inverter.

11. The method according to claim 10, further comprising selecting any one of a 120° rectangular wave and a sine wave to drive the inverter when it is determined that the detected rotation number of the motor is less than the predetermined reference rotation number.

12. The method according to claim 10, further comprising selecting a 150° rectangular wave to drive the inverter when it is determined that the detected rotation number of the motor is greater than or equal to the predetermined reference rotation number.

13. The method according to claim 11, further comprising determining whether high operation efficiency or reduction of noise is required to select the wave when the detected rotation number of the motor is less than the predetermined reference rotation number.

14. The method according to claim 13, wherein the 120° rectangular wave is selected when it is determined that the high operation efficiency is required.

15. The method according to claim 13, wherein the sine wave is selected when it is determined that the reduction of noise is required.

16. The method according to claim 11, wherein the 120° rectangular wave has an energization angle of approximately 120 degrees to 130 degrees.

17. The method according to claim 12, wherein the 150° rectangular wave has an energization angle of approximately 140 degrees to 160 degrees.

18. A compressor driving apparatus, comprising:
a motor including a rotator;
an inverter supplying power to the motor;
a rotator position detector detecting a position of the rotator of the motor; and
an inverter drive controller including at least two wave generators each generating an optimal driving wave according to a result of the detected position of the rotator.

19. The compressor driving apparatus according to claim 18, wherein the optimal driving wave is generated according to a high speed operation or a low speed operation, one of the wave generators generating a 150° rectangular wave according to the high speed operation and at least one other of the wave generators generating one of a sine wave and a 120° rectangular wave according to the lower speed operation.

20. The compressor driving apparatus according to claim 19, wherein a first of the at least one other of the wave generators generates the 120° rectangular wave when a high efficiency operation is required and a second of the at least one other of the wave generators generates the sine wave when a high efficiency operation is not required.
